(19) United States
(12) Patent Application Publication
(10) Pub. No.: US 2009/0002484 A1
(43) Pub. Date: Jan. 1, 2009

(54) Method and Apparatus for Correcting Misalignment of a Lenticular in a 3-D Television Receiver

(75) Inventors: Gerardus Petrus Karman, 'S-Hertogenbosch (NL); Siebe T Jerk De Zwart, Valkenswaard (NL); Mireille Reijme, Utrecht (NL)

Correspondence Address: PHILIPS INTELLECTUAL PROPERTY & STANDARDS, P.O. BOX 3001, BRIARCLIFF MANOR, NY, 10510, US

(73) Assignee: KKONINKLIJKE PHILIPS ELECTRONICS, N.V., EINDHOVEN (NL)

(21) Appl. No.: 12/158,407

(22) PCT Filed: Dec. 14, 2006
(86) PCT No.: PCT/IB2006/054856

§ 371 Date: Jun. 20, 2008

Related U.S. Application Data
(60) Provisional application No. 60/752,077, filed on Dec. 20, 2005.

(51) Int. Cl. H04N 13/04; H04N 3/22

(52) U.S. Cl. 348/54; 348/745; 348/E13.001; 348/E03.04

(57) ABSTRACT

A projection television receiver is given 3-dimensional functionality by mounting a lenticular array of substantially vertically arranged cylindrical lenses in front of the display screen. The position of this lenticular array is critical to the performance of the 3-D functionality. In order to correct for misalignment, the lenticular array is equipped with a photo-sensor on the side facing the display. The display is then controlled to selectively energize the pixels such that the actual position of the lenticular array can be determined. The displayed image is then shifted based on the measurement such that the user will see an optimal 3-D image quality.

The subject invention relates to a matrix-type projection television receiver having three-dimensional (3-D) functionality.

The construction of a matrix-type 3-D display is relatively straightforward. An array of cylindrical lenses, referred to as lenticules, is placed on top of the rear projection screen of an existing matrix-type projection television receiver.

Typical sizes of pixels on the matrix imager chip are 10 micrometers, while the pixels on the display screen are the order of a few hundred micrometers (depending on the screen size. However, the width of a single lenticule is equal to several screen-size pixels, depending on the number of views of the 3-D display.

A point of concern is that during manufacturing of the projection television receiver, the matrix-type chip has to be positioned extremely precisely, since a small lateral displacement of the chip leads to a big displacement of the pixels on the display screen due to the large magnification of the image generated on the matrix-type chip and the displayed image by a lens array. A lateral shift of the pixels on the display screen results in a distorted 3-D image, i.e., the lenticules will then image the pixels in the wrong direction. The entire 3-D image will then appear to be rotated toward the left or right, depending on the positioning error of the matrix-type chip.

While in a well-controlled production process all optical elements, i.e., the matrix-type chip, the magnifying lenses, the display screen and the lenticular array, may be mounted in such an accurate manner that these errors are small, when the television receiver is used in real life, it is to be expected that at some point misalignments will arise, e.g., due to impact during shipping, installation, etc.

An object of the present invention is to provide a method for correcting misalignment of a lenticular array in a 3-D television receiver, wherein said television receiver comprises a display having an array of pixels, a lenticular array overlying said display, and circuitry for receiving a video signal and for activating said pixels in response to said video signal.

This object is achieved in a method as described above, the method comprising the steps of mounting a photo-sensor on the illuminating side of said lenticular array in a predetermined position; successively illuminating the pixels in a row of said array of pixels in said display; measuring an output signal of said photo-sensor for each of said successively illuminated pixels; determining a lateral position of said lenticular array in response to which of said successively illuminated pixels generates a maximum output signal of said photo-sensor; and adjusting a lateral position of an image generated by said display in response to the determined position of said lenticular array.

A further object of the invention is to provide an apparatus for correcting misalignment of a lenticular array in a 3-D television receiver, said apparatus comprising a display having an array of a plurality of pixels; a lenticular array overlying said display, said lenticular array having a plurality of vertically arranged cylindrical lenses; a processor having an input for receiving a video signal, said processor generating an image on said display by selectively energizing said pixels in response to said video signal; and a photo-sensor arranged in a predetermined position on a side of said lenticular array facing said display, wherein said processor is arranged to successively energize pixels in a selected row on said display, measure an output of said photo-sensor for each of said successively illuminated pixels, determine a lateral position of said lenticular array based on which of said successively illuminated pixels generates a maximum output signal from said photo-sensor, and adjusts a lateral position of an image generated on said display in response to the determined position of the lenticular array.

With the above method and apparatus, Applicants have found that the most critical misalignment problems, i.e., lateral shifts, can be corrected by merely shifting the image laterally an appropriate number of pixel positions. While vertical misalignment may exist, Applicants have found that as the cylindrical lenses in the lenticular array are oriented with their optical axes substantially vertical, the entire system is very stable against vertical misalignment.

However, in the case of a 2D lenslet array, vertical misalignment may lead to serious optical problems. To that end, the method and apparatus of the subject invention may be adapted to detect and correct for vertical misalignment.

With the above and additional objects and advantages in mind as will hereinafter appear, the invention will be described with reference to the accompanying drawings, in which:

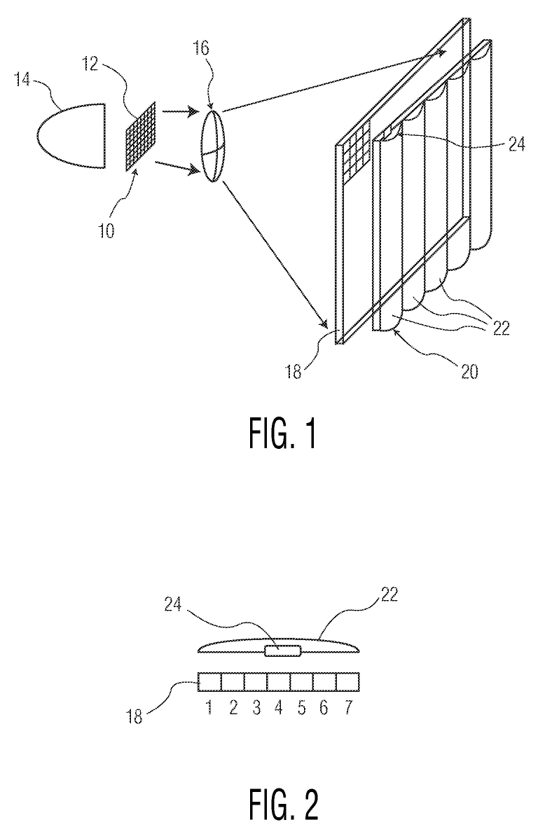

FIG. 1 shows a block diagram of a projection television receiver incorporating the subject invention; and

FIG. 2 is a top view showing the positioning of the photo-sensor with respect to the display; and

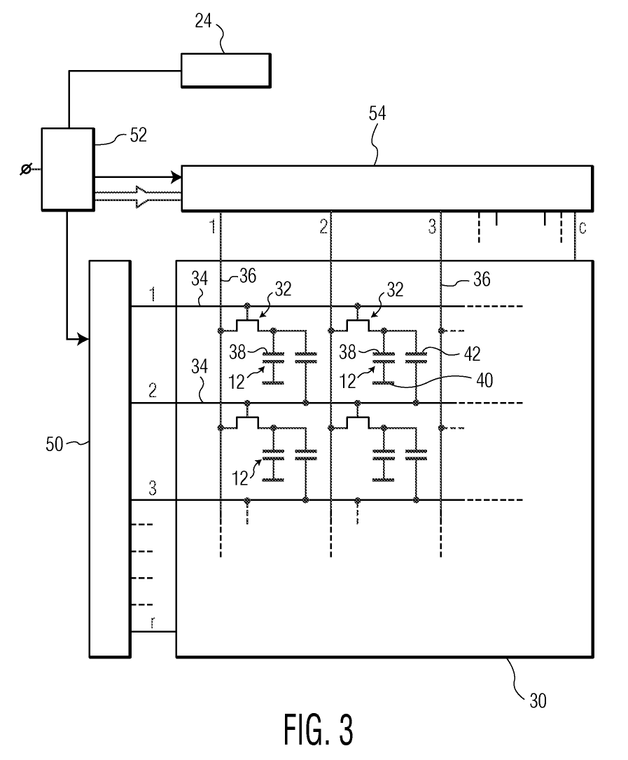

FIG. 3 shows a block schematic diagram of a matrix-type imager.

FIG. 1 shows a block diagram of a projection television receiver in which a matrix-type imager 10 forms a image to be displayed. The imager 10 includes a plurality of pixels 12 arranged in rows and columns. A light source 14 projects light through the imager 10, in the case of a transmissive imager, or reflects light from the imager 10, in the case of a reflective image, thereby forming an image which is magnified by projecting lenses 16. A resulting image, formed by pixels corresponding to the pixels 12, is then projected onto display screen 18.

A lenticular array 20, including a plurality of vertically arranged cylindrical lenses 22, is arranged in front of the display screen 18 to form a 3-D image. Reference is made to U.S. Pat. No. 6,118,584, incorporated herein by reference, which discloses an autostereoscopic display apparatus in which a lenticular array is positioned overlying a display panel.

As shown in FIG. 1, a photo-sensor 24 is arranged in a predetermined position on the surface of the lenticular array 20 facing the display screen 18. The photo-sensor 24 is preferably positioned at the top of the lenticular array 20 outside of the visible area of the display of the television receiver. FIG. 2 shows a top view of the positioning of the photo-sensor 24 which is shown as being positioned in front of pixel no. 4.

FIG. 3 shows a block schematic diagram of the imager 10. The imager 10 includes an active matrix addressed liquid crystal display panel 30 having a row and column array of display elements which consist of r rows (l to r) with c horizontally arranged picture display elements (pixels) 12 (l to c) in each row. Only a few of the display elements are shown for simplicity.

Each display element 12 is associated with a respective switching device in the form of a thin film transistor, TFT 32. The gate terminals of all TFTs 32 associated with display elements in the same row are connected to a common row conductor 34 to which, in operation, selection pulse (gating) signals are supplied. Likewise, the source terminals of the TFTs associated with all display elements in the same column are connected to a common column conductor 36 to which data (video) signals are applied. The drain terminals of the TFTs are each connected to a respective transparent display element electrode 38 forming part of, and defining, the display element. The sets of conductors 34 and 36, TFTs 32 and electrodes 38 are carried on one transparent plate, while a second, spaced, transparent plate carriers and electrode 40 common to all display elements. Liquid crystal material is disposed between the plates and each display element comprises the electrode 38 and overlying portions of the liquid crystal layer and the common electrode 40. Each display element further includes a storage capacitor 42 which is connected between the display element electrode 38 and a row conductor 34 adjacent to that which the TFT 32 associated with the display element is connected.

In operation, light from light source 14 disposed on one side enters the panel and is modulated according to the transmission characteristics of the display elements 12. The device is driven on a row at a time basis by scanning the row conductors 34 sequentially with a selection pulse signal so as to turn on each row of TFTs in turn in a respective row address period and applying data (video) signals to the column conductors for each row of display elements in turn as appropriate and in synchronism with gating signals so as to build up over one field a complete display picture. Using one row at a time addressing, all TFTs 32 of the addressed row are switched on for a period determined by the duration of the selection pulse signal, which corresponds to less than an applied video signal line period, during which the data information signals are transferred from the column conductors 36 to the display elements 12. Upon termination of the selection signal, the TFTs 32 of the row are turned off for the remainder of the field time thereby isolating the display elements from the conductors 36 and ensuring the applied charge is stored on the display elements until the next time they are addressed, usually in the next field period.

The row conductors 34 are supplied successively with selection pulse signals by a row drive circuit 50 comprising a digital shift register controlled by regular timing pulses from a processor 52. For a major part of the intervals between selection signals, the row conductors 14 are supplied with a substantially constant reference potential, e.g., zero volts, by the drive circuit 50 to hold the TFTs in their off state. Video information signals are supplied to the column conductors 36 from a column drive circuit 54 of conventional form comprising one or more shift register/sample-and-hold circuits. The drive circuit 54 is supplied with video signals and timing pulses from the processor 52 in synchronism with row scanning to provide serial to parallel conversion appropriate to the row at a time addressing of the panel.

In addition, the photo-sensor 24 is shown electrically connected to the processor 52.

In an alignment mode, the processor 52 turns off all of the pixels 12 except for one pixel in the upper left corner of the display panel 30. At the same time, the processor 52 measures the output signal of the photo-sensor 24. The processor 52 then turns off this pixel 12 and turns on the neighboring pixel in the same row and measures the output signal of the photo-sensor 24. This process is repeated by the processor 52 for successive pixels until the output signal from the photo-sensor 24 reaches a maximum level. This happens when the pixel 12 over which the photo-sensor 24 is positioned is turned on. This would be pixel no. 4 as shown in FIG. 2. Since the position of the photo-sensor 24 with respect to the optical axes of the cylindrical lenses of the lenticular array is known, it is now known which pixels on the display panel are imaged into which directions, e.g., in the case that the photo-sensor 24 is located exactly at the center of one of the cylindrical lenses (see FIG. 2), the pixel no. 4 is imaged into the normal viewing direction, while its neighbors then correspond to the first views to the left/right, etc. The processor 52 then uses this information to process the 3-D images so that the display panel receives the correct information, i.e., the processor 52 applies a lateral shift to the image on the display panel by a fixed number of pixel positions.

In an alternate embodiment of the invention, instead of mounting the photo-sensor 24 on the lenticular array, a reflector may instead be mounted on the lenticular, while a photo-sensor is mounted to the frame of the projection television receiver positioned in order to detect light reflected from the reflector. As such, wires connecting the photo-sensor 24 to the processor 52 do not need to be conducted from the lenticular array.

As indicated above, correction of misalignment in the vertical direction may not be necessary. However, if desired, the photo-sensor 24 may be additionally positioned at the side edge of the lenticular array (e.g., just outside of the upper left corner of the visible area of the display), and the processor successively turns on pixels in a select column while again measuring the output signal from the photo-sensor 24. Based on the positioning of the maximum output signal, the position of the image with respect to the sensor may be determined, and the image may then be shifted up or down, accordingly.

In the above description, only one photo-sensor is used. However, more than one photo-sensor may be used to increase accuracy. For example, by placing one or more photo-sensors in each corner of the lenticular array (e.g., just outside of the corners of the visible area of the display), corrections may additionally be made for temperature dependent expansion of the lenticular array. In this case, a simple lateral shift of pixel position in the image data may not be sufficient. To that end, the entire image may be scaled up or down or may be deformed by a very small percentage since differences in expansion due to temperature changes are very small.

The principles of the subject invention may be extended to perform separate alignment measurements/corrections for different colors so as to correct for possible achromatic aberrations of the entire optical system.

While the above description has been based on a projection television receiver, it is conceivable that the subject invention is also applicable to direct view television receivers using LCD or plasma technology. In the near future, the resolutions of these displays will increase and as such, the alignment requirements will also increase so that at some point the alignment correction method of the subject invention will become applicable.

Although this invention has been described with reference to particular embodiments, it will be appreciated that many variations will be resorted to without departing from the spirit and scope of this invention as set forth in the appended claims. The specification and drawings are accordingly to be regarded in an illustrative manner and are not intended to limit the scope of the appended claims.

In interpreting the appended claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope;

d) several “means” may be represented by the same item or hardware or software implemented structure or function;

e) any of the disclosed elements may be comprised of hardware portions (e.g., including discrete and integrated electronic circuitry), software portions (e.g., computer programming), and any combination thereof,

f) hardware portions may be comprised of one or both of analog and digital portions;

g) any of the disclosed devices or portions thereof may be combined together or separated into further portions unless specifically stated otherwise; and

h) no specific sequence of acts is intended to be required unless specifically indicated.

1. A method for correcting misalignment of a lenticular array (20) in a 3-D television receiver, said television receiver comprising a display (10, 30) having an array (30) of pixels (12), a lenticular array (20) overlying said display, and circuitry (52, 54, 56) for receiving a video signal and for activating said pixels in response to said video signal, said method comprising the steps of:
mounting light sensing means (24) on the illuminating side of said lenticular array (20) in a predetermined position;
successively illuminating (54, 56) the pixels (12) in a row of said array (30) of pixels in said display;
measuring (52) an output signal of said light sensing means 24) for each of said successively illuminated row pixels (12);
determining (52) a lateral position of said lenticular array (20) in response to which of said successively illuminated row pixels (12) generates a maximum output signal of said light sensing means (24); and
adjusting (52) a lateral position of an image generated by said display in response to the determined lateral position of said lenticular array (20).

2. The method as claimed in claim 1, wherein said light sensing means (24) is a photo-sensor.

3. The method as claimed in claim 1, wherein said step of mounting light sensing means (24) comprises:
mounting a reflector in a predetermined position on an illuminated surface of said lenticular array (20); and
mounting a photo-sensor (24) on a frame of said television receiver for optically cooperating with said reflector.

4. The method as claimed in claim 1, wherein said step of mounting a photo-sensor (24) comprises mounting the light sensing means (24) outside of a visible area of the television receiver.

5. The method as claimed in claim 1, wherein said method further comprises the steps of:
successively illuminating (52, 54, 56) the pixels (12) in a column of said array of pixels in said display (30);
measuring (52) an output signal of said light sensing means (24) for each of said successively illuminated column pixels (12);
determining (52) a vertical position of said lenticular array (20) in response to which of said successively illuminated column pixels (12) generates a maximum output signal of said light sensing means (24); and
adjusting (52) a vertical position of an image generated by said display (30) in response to the determined vertical position of said lenticular array (20).

6. A method for correcting misalignment of a displayed image with respect to a lenticular array in a 3-D television receiver, said television receiver comprising a display (10, 30) having an array of pixels (12), a lenticular array (20) overlying said display (10, 30), and circuitry (52, 54, 56) for receiving a video signal and for activating said pixels (12) in response to said video signal, said method comprising the steps of:
mounting light sensing means (24) on the illuminating side of said lenticular array (20) in predetermined positions, said predetermined positions corresponding to areas outside of the four corners of a visible display area on the lenticular array (20);
successively illuminating (52, 54, 56) the pixels (12) in an upper row and a lower row of said array of pixels in said display;
measuring (52) output signals of said light sensing means (24) for each of said successively illuminated row pixels (12);
successively illuminating (52, 54, 56) the pixels (12) in a left and right column of said array of pixels in said display (30);
measuring (52) output signals of said light sensing means 24) for each of said successively illuminated column pixels (12);
determining (52) a position, lateral and vertical, size and/or distortion of said lenticular array (20) in response to which of said successively illuminated row pixels (12) generate maximum output signals of said light sensing means (24); and
adjusting (52) a position, size and/or distortion of an image generated by said display in response to the determined position, size and distortion of said lenticular array (20).

7. An apparatus for correcting misalignment of a lenticular array in a 3-D television receiver, said apparatus comprising:
a display (10, 30) having an array of a plurality of pixels (12);
a lenticular array (20) overlying said display (10, 30), said lenticular array (20) having a plurality of vertically arranged cylindrical lenses (22);
a processor (52) having an input for receiving a video signal, said processor (52) generating an image on said display (10, 30) by selectively energizing (54, 56) said pixels (12) in response to said video signal; and
light sensing means (24) arranged in a predetermined position on a side of said lenticular array (20) facing said display (10, 30),
wherein said processor (52) is arranged to successively energize pixels (12) in a selected row on said display (30), measure an output of said light sensing means (24) for each of said successively illuminated row pixels (12), determine a lateral position of said lenticular array (20) based on which of said successively illuminated row pixels (12) generates a maximum output signal from said light sensing means (24), and adjust a lateral position of an image generated on said display (30) in response to the determined lateral position of the lenticular array (20).

8. The apparatus as claimed in claim 7, wherein said light sensing means (24) is a photo-sensor.

9. The apparatus as claimed in claim 7, wherein said light sensing means (24) comprises:
a reflector mounted in a predetermined position on an illuminated surface of said lenticular array (20); and
a photo-sensor (24) mounted on a frame of said television receiver for optically cooperating with said reflector.

10. The apparatus as claimed in claim 7, wherein said light sensing means (24) is mounted on said lenticular array (20) outside of a visible area of the television receiver.

11. The apparatus as claimed in claim 7, wherein said processor (52) is further arranged to successively energize (54, 56) pixels (12) in a selected column on said display (30), measure an output of said light sensing means (24) for each of said successively illuminated column pixels (12), determine a vertical position of said lenticular array (20) based on which of said successively illuminated column pixels (12) generates a maximum output signal from said light sensing means (24), and adjusts a vertical position of an image generated on said display (30) in response to the determined vertical position of the lenticular array (20).
